(19) United States
(12) Patent Application Publication
(10) Pub. No.: US 2002/0162849 A1
(43) Pub. Date: Nov. 7, 2002

(54) Structure art design knife blade container

(76) Inventor: Fang Yeh Chen, Taichung City (TW)

Correspondence Address: FANG YEH CHEN, P.O. BOX 63-150, Taichung City, TW

(21) Appl. No.: 09/961,451

(22) Filed: Sep. 22, 2001

(30) Foreign Application Priority Data
May 4, 2001 (TW) 90207420

(51) Int. Cl. B26B 1/00; B65D 83/00

(52) U.S. Cl. 221/65; 30/1

(57) ABSTRACT

An improved structure art knife blade container comprised of an inner case that slides lengthwise into an outer case. An elastic component is positioned lengthwise between the interior section of the outer case and the side of the inner case, thereby providing a spring force to push the inner case outward in a straight line, and a recess capable of holding a plurality of art design knife blades in a stacked arrangement is formed in the inner case. As such, during the sliding operation of the inner and outer case, a horizontal ejection rib contacts the uppermost art design knife blade in the inner case and ejects it horizontally from a dispensing slot, thereby achieving the convenient dispensing of art design knife blades.

### BACKGROUND OF THE INVENTION

1) Field of the Invention

The invention herein relates to an improved structure art knife blade container that is advantageously finger-operated to eject single a blade and, furthermore, is safe and convenient to utilize.

2) Description of the Prior Art

The conventional plastic container (as shown in FIG. 1) of art design knife blades is typically comprised of a box 1 and a cover 2, wherein the said box 1 provides for the simple stacked placement of a certain quantity of art design knife blades 3 and then the cover 2 is slipped onto the box 1 to hold the art design knife blades 3 inside; as such, when an art design knife blade 3 is needed, the cover 2 is removed from the box 1 to expose the art design knife blades 3 and then a single art design knife blade 3 is manually separated and extricated for use; while the hand is singling out an art design knife blade 3, extreme caution must be exercised; otherwise, fingers are easily cut; this is mainly due to the stacked arrangement of the art design knife blades 3, which are usually clumped together and, furthermore, because the art design knife blades 3 have a certain weight; at the same time, the surrounding four sides of the box 1 pose further difficulty as the fingers attempt to access a single blade; therefore, such conventional art design knife blade containers can be described as remarkably unsophisticated box structures having no additional capabilities.

In view of this, the inventor of the invention herein, based on many years of experience gained while engaged in the production and marketing of related plastic packaging containers, conducted extensive research and development as to possible improvements that culminated in an art design knife container of utmost utility.

### SUMMARY OF THE INVENTION

The primary objective of the invention herein is to provide an improved structure art knife blade container, the spatial configuration of which enables the rapid and, furthermore, convenient withdrawal of blades, while also preventing finger injuries due to manual blade separation and extraction.

Therefore, the improved structure art knife blade container of the invention herein is comprised of an inner case that slides lengthwise into an outer case; an elastic component is positioned lengthwise between the interior section of the outer case and side of the inner case, thereby providing a spring force to push the said inner case outward in a straight line; a recess capable of holding a plurality of art design knife blades in a stacked arrangement is formed in the inner case and an elastically braced, vertically oriented carrier plate is situated at the bottom side of the said recess that supports the said art design knife blades stacked on its top end and maintains them in an even horizontal position against the interior top side of the said outer case; a dispensing slot, the height of which accommodates the lateral thickness of a single art design knife blade and the passage through thereof, is formed at the lengthwise front end of the said inner case; and a horizontal ejection rib projects downward across the top interior side of the outer case and is situated in the slide path of the inner case and, furthermore, the cross-sectional thickness of the horizontal ejection rib does not exceed the lateral thickness of a single art design knife blade; as such, during the sliding operation of the said inner and outer case, the horizontal ejection rib contacts the uppermost art design knife blade within the inner case and ejects it horizontally from the dispensing slot, thereby achieving the convenient dispensing of art design knife blades.

To enable the examination committee a further understanding of and familiarity with the objective, features, and functions of the present invention, the most preferred embodiments are accompanied by the brief description of the drawings below and followed by the detailed description of the invention.

### BRIEF DESCRIPTION OF THE DRAWINGS

FIG. 1 is an exploded drawing of a conventional art design knife blade container.

FIG. 2 is an exploded drawing of the most preferred embodiment of the invention.

FIG. 3 is a cross-sectional drawing of the most preferred embodiment of the invention herein.

FIG. 4 is a cross-sectional drawing of the most preferred embodiment of the invention herein that illustrates its operation. (A)

FIG. 5 is a cross-sectional drawing of the most preferred embodiment of the invention herein that illustrates its operation. (B)

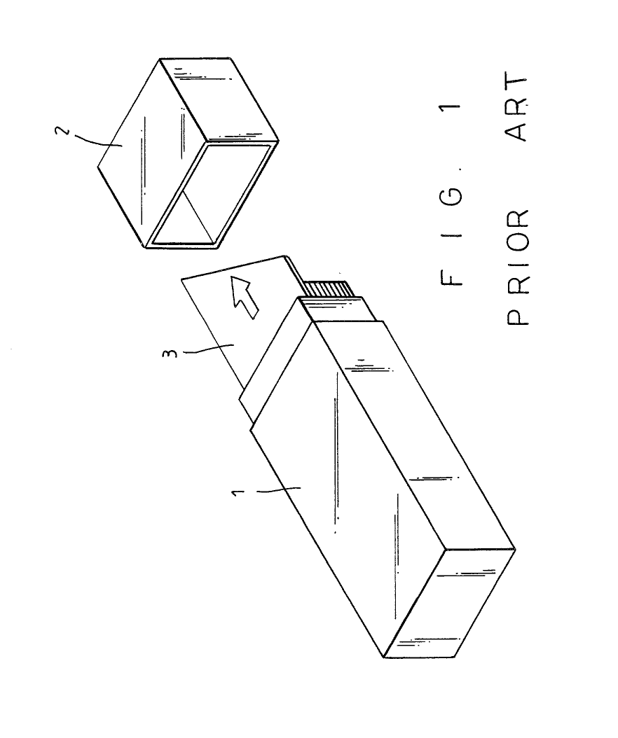

### DETAILED DESCRIPTION OF THE INVENTION

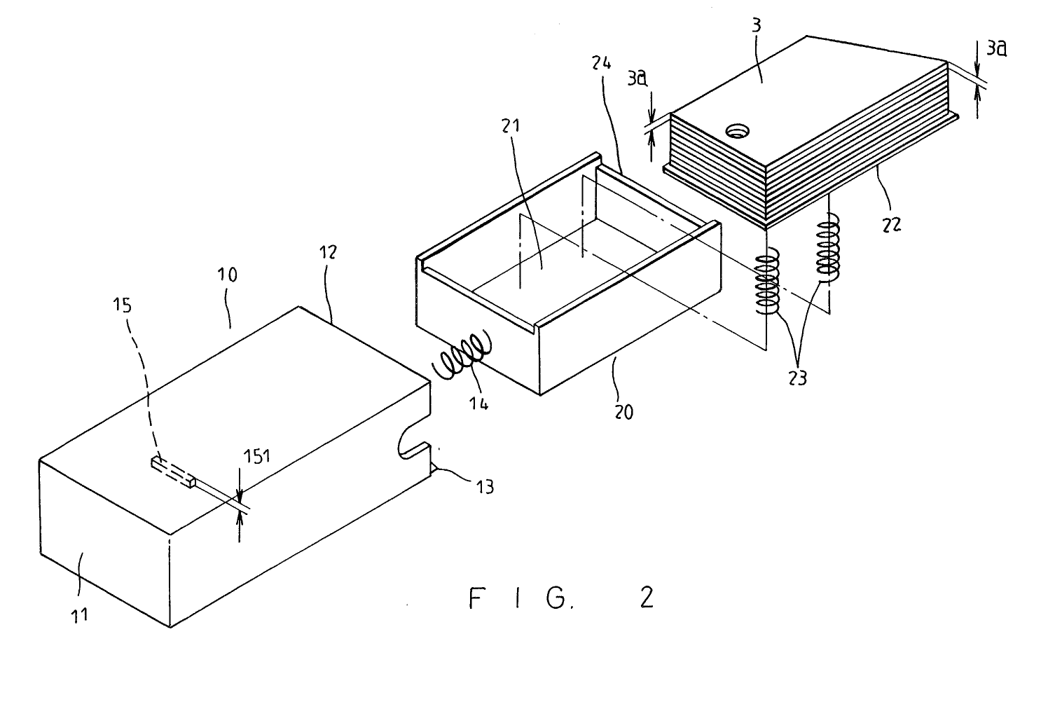

Referring to FIG. 2 and FIG. 3, the improved structure art knife blade container of the invention herein is comprised of an inner case 20 that slides lengthwise into an outer case 10, of which:

The said outer case 10 is a rectangular surrounding structure having a closed end 11 at one lengthwise extremity and a unidirectional opening 12 at the opposite extremity, and a retaining lip 13 is formed along the bottom edge of the said unidirectional opening 12 and, furthermore, projects at an angle to prevent the inner case 20 from sliding out; an elastic component 14 is positioned lengthwise inside the said closed end 11 and provides a spring force to push the said inner case 20 outward in a straight line; a horizontal ejection rib 15 projects downward across the top interior side of the outer case 10 and is situated in the slide path of the inner case 20 and, furthermore, the cross-sectional thickness 151 of the horizontal ejection rib 15 does not exceed the lateral thickness 3a of a single art design knife blade 3.

The said inner case 20 is a rectangular box-like structure having an exterior width that is slightly smaller than the interior width of the said outer case 10 unidirectional opening 12 and, therefore, is capable of sliding lengthwise into the unidirectional opening 12 of the outer case 10; a recess 21 capable of holding a plurality of art design knife blades 3 in a stacked arrangement is formed within the upper extent and an elastically braced, vertically oriented carrier plate 22 is situated at the bottom side of the said recess 21, the said vertically oriented carrier plate 22 having installed below it a set of elastic components 23 that support the said art design knife blades 3 stacked on its top end and maintain them in an even horizontal position against the interior top side of the said outer case 10 (as shown in FIG. 3); and a dispensing slot 24, the height of which accommodates the lateral thickness 3a of a single art design knife blade 3 and the passage through thereof, is formed at the lengthwise front end of the said inner case 20.

Given the said assembly of the improved structure art knife blade magazine of the invention herein, as indicated in FIG. 3, a quantity of art design knife blades 3 is stacked sequentially onto the said vertically oriented carrier plate 22, while the elastic components 23 become compressed as the art design knife blades 3 are loaded into the said recess 21; the inner case 20 filled with art design knife blades 3 is then inserted lengthwise like a drawer into the unidirectional opening 12 of the outer case 10; as such, the said art design knife blades 3 are held fast by the vertically oriented carrier plate 22 and the supporting action of the elastic components 23 such that the top end of the art design knife blades 3 is maintained horizontally against the interior top side of the said outer case 10; in addition, the inner case 20 is impelled by the elastic component 14 loaded against one side such that it moves towards the unidirectional opening 12 of the outer case 10; however, since its end opening is at the same time situated against the angled projection of the horizontal ejection rib 15, the inner case 20 is prevented from sliding out.

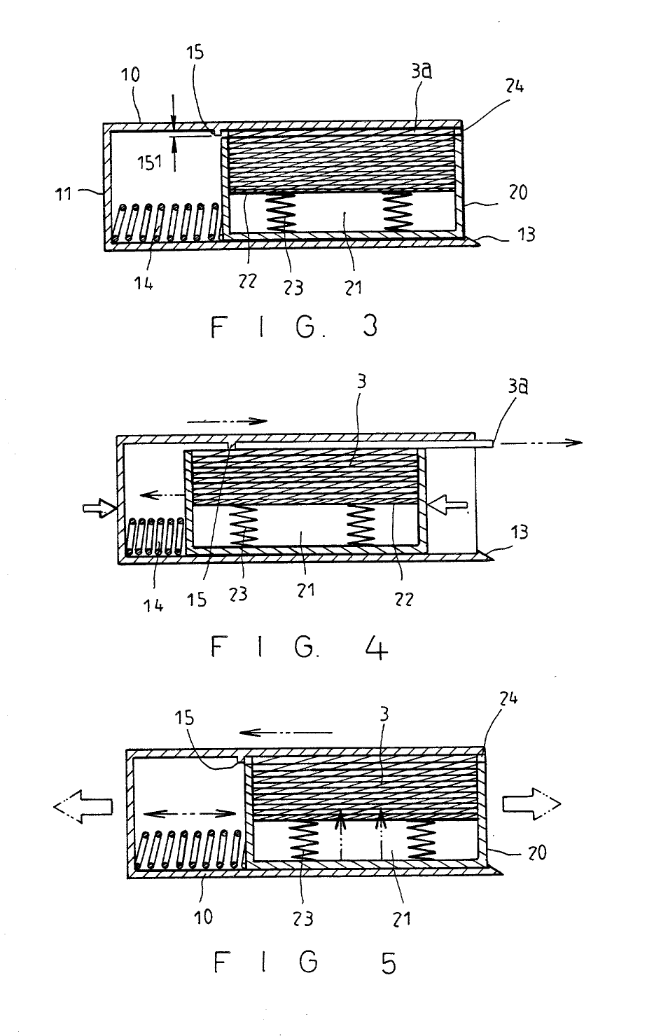

Referring to FIG. 4 and FIG. 5, when an art design knife blade 3 is needed for use, it is only necessary to apply pressure at the two lengthwise ends of the assembled inner and outer case 20 and 10 utilizing two fingers, as indicated by the directional arrowheads in FIG. 4, whereupon the said inner case 20 moves into the interior of the outer case 20 and the elastic component 14 at its lengthwise rear is compressed during course of motion, while the outer case 20 also moves towards the said inner case 10 in the process; since the said horizontal ejection rib 15 has a cross-sectional thickness 151 that is smaller than the lateral thickness 3a of a single art design knife blade 3, the uppermost art design knife blade 3 is pushed horizontally and a single art design knife blade 3 is ejected in an even and horizontal manner from the dispensing slot 24; the two fingers are then released from two lengthwise ends of the inner and outer case 20 and 10 to terminate the application of pressure, thereby relieving the compressive force of the elastic component 14 and, as indicated in FIG. 5, the said inner and outer case 20 and 10 return in the opposite direction, while the supportive operation of the vertically oriented carrier plate 22 and the elastic components 23 allows another single art design knife blade 3 to be sent from the stack of art design knife blades 3, the repeating cycle of operation providing for the rapid and, furthermore, convenient dispensing of art design knife blades 3.

In summation of the foregoing section, the major function of the invention herein consists of fully facilitating the withdrawal of art design knife blades 3 by the user in that after the light application of pressure by the fingers, a single art design knife blade 3 is immediately dispensed and fingers are not needed for pushing aside other blades to obtain one blade; additionally, when the art design knife blades 3 of the present invention are sold, each is coated with an anti-corrosive agent that prevents rusting and, furthermore, since unused blades are extremely sharp and finger injuries often occur during manual separation and extraction, the invention herein is not only a design allowing totally safe storage, its most significant feature being the capability of effectively providing for an exceptionally simple and safe dispensing operation with utmost practicality; furthermore, since no identical or similar structured product was observed on the market, the invention herein meets patent law regulations and is hereby submitted in application to the patent bureau.

1. An improved structure art knife blade container comprised of an inner case that slides lengthwise into an outer case; an elastic component is positioned lengthwise between the interior section of the said outer case and side of the said inner case, thereby providing a spring force to push the said inner case outward in a straight line; a recess capable of holding a plurality of art design knife blades in a stacked arrangement is formed in the said inner case and an elastically braced, vertically oriented carrier plate is situated at the bottom side of the said recess that support the said art design knife blades stacked on its top end and maintains them in an even horizontal position against the interior top side of the said outer case; a dispensing slot, the height of which accommodates the lateral thickness of a single said art design knife blade and the passage through thereof, is formed at the lengthwise front end of the said inner case; and a horizontal ejection rib projects downward across the top interior side of the said outer case and is situated in the slide path of the said inner case and, furthermore, the cross-sectional thickness of the said horizontal ejection rib does not exceed the said lateral thickness of a single said art design knife blade; as such, during the sliding operation of the said inner and outer case, the said horizontal ejection rib contacts the uppermost said art design knife blade in the said inner case and ejects it horizontally from the said dispensing slot, thereby achieving the convenient dispensing of said art design knife blades.

2. As mentioned in claim 1 of the improved structure art knife blade container of the invention herein, the said outer case is a rectangular surrounding structure having a unidirectional opening and the said inner case is a rectangular box-like structure having an exterior width that is slightly smaller than the interior width of the said outer case unidirectional opening and, therefore, is capable of sliding lengthwise into the said unidirectional opening of the said outer case; the said outer case has a retaining lip formed along the bottom edge of the said unidirectional opening that is aligned with the bottom side of the said inner case and, furthermore, projects at an angle to prevent the sliding out of the said inner case.
